(19) United States
(12) Patent Application Publication
(10) Pub. No.: US 2022/0157033 A1
(43) Pub. Date: May 19, 2022

(54) SYSTEM AND METHOD TO GENERATE MODELS USING INK AND AUGMENTED REALITY

(71) Applicant: AiFi Corp, Santa Clara, CA (US)

(72) Inventors: Ying Zheng, Santa Clara, CA (US); JUAN TERVEN, Santa Clara, CA (US); Qingyun Sun, Santa Clara, CA (US); Steve Gu, Santa Clara, CA (US); Shuang Liu, Santa Clara, CA (US)

(73) Assignee: AiFi Corp, Santa Clara, CA (US)

(21) Appl. No.: 17/098,349

(22) Filed: Nov. 14, 2020

(51) Int. Cl. G06T 19/20; G06T 19/00; B42D 25/382; B42D 25/387; G06T 7/13

(52) U.S. Cl. CPC G06T 19/20; G06T 19/006; B42D 25/382; B42D 25/387; G06T 2207/20081; G06T 2207/10048; G06T 2207/10028; G06T 2207/20084; G06T 7/13

(57) ABSTRACT

This application relates to systems, methods, devices, and other techniques for methods with cameras and specialized ink spreads and augmented reality technology that can be utilized to generate models within an auto-checkout system within a retail environment

### BACKGROUND OF THE INVENTION

This application relates to systems, methods, devices, and other techniques that can be utilized to generate models by spraying specialized ink on items within a retail environment.

Methods and apparatus to generate models for testing and training neural networks in a retail store to monitor products and customers are in practice. However, generating models by using ink that could be invisible to human eyes onto items within a retail environment is new. Furthermore, these techniques and methods can be combined with recently developed AI, machine learning and augmented reality to make the purchase process more accurate and efficient.

Therefore, it is desirable to have new systems, methods, devices, and other techniques to generate models by spraying specialized ink on items and using and augmented reality techniques in a retail environment.

### SUMMARY OF THE INVENTION

In some embodiments, the invention is related to a method of generating models, comprising a step of spaying a type of ink to items in a retail environment, wherein the type of ink is not visible to RGB camera and human eyes, wherein the type of ink is visible to a special camera. In some embodiments, the method is comprising a step of capturing a set of images of the items, wherein each image of the set of images depicting at least a portion of edges of the items by at least one special cameras; In some embodiments, the method comprises a step of forming bounding boxes from the set of images of the items for each item of the items; In some embodiments, the method comprises a step of generating models for the items from the bounding boxes.

In some embodiments, the method comprises a step of rendering environments comprising the items, customers, shelves and camera systems by combining models for the items and images captured by other RGB cameras.

In some embodiments, the method comprises a step of training a neural network by environments.

In some embodiments, the method comprises a step of testing the neural network with various cases of customer and item interactions. In some embodiments, the special camera is configured to detect infrared signals. In some embodiments, the special camera is configured to detect ultraviolet signals. In some embodiments, the method is further comprising a step of taking another set of images of the items by a RGB camera. In some embodiments, the method is further comprising a step of combining the set of images and another set of images to generate another set of models. In some embodiments, the set of images can be viewed by machines. In some embodiments, the type of ink only sprayed to a segmentation of the items.

In some embodiments, the invention is related to a method of to differentiate products, comprising: a step of spaying a first type of ink to a first set of items in a retail environment, wherein the first type of ink is not visible to RGB camera and human eyes, wherein the first type of ink is visible to a first special camera; a step of spaying a second type of ink to a second set of items in the retail environment, wherein the second type of ink is not visible to RGB camera and human eyes, wherein the second type of ink is visible to a second special camera, wherein the first type of ink is not visible to a second special camera, wherein the second type of ink is not visible to a first special camera; a step of capturing a first set of images of the first set of items by the first special camera; a step of forming a first set of bounding boxes from the first set of images with a first set of labels; a step of forming a second set of bounding boxes from the second set of images with a second set of labels, wherein the first set of labels are different from the second set of labels; a step of generating a first set of models from the first set of bounding boxes with the first set of labels and a second set of models from the second set of bounding boxes with the second set of labels; a step of rendering environments comprising the first set of models, the second set of models, customers, shelves and camera systems; a step of training a neural network by the environments; and a step of testing the neural network with various cases of customer and item interactions. In some embodiments, the special camera is configured to detect infrared signals. In some embodiments, the special camera is configured to detect ultraviolet signals. In some embodiments, the method is further comprising a step of taking another set of images of the items by a RGB camera. In some embodiments, the method is further comprising a step of combining the set of images and another set of images to generate another set of models. In some embodiments, the set of images can only viewed by machines. In some embodiments, the type of ink only sprayed to a segmentation of the first set of items.

In some embodiments, the invention is related to a method to generate models, comprising: a step of spaying a type of ink to a segment of an item in a retail environment, wherein the type of ink is not visible to RGB camera and human eyes, wherein the type of ink is visible to a special camera; a step of capturing a first set of images of the segment of the item by a special camera; a step of capturing a second set of images of the items by a RGB camera; a step of forming bounding boxes from combination of the first set of images and the second set of images; a step of generating a first model for the segment of the item and a second model for the item from the bounding boxes; a step of rendering environments comprising the items, customers, shelves and camera systems by combining the first model for the segment of the item and the second model for the item and images captured by other RGB cameras; a step of training a neural network by the environments; and a step of testing the neural network with various cases of customer and item interactions. In some embodiments, the method is further comprising of capturing a third set of images of the items by a RGBD camera; In some embodiments, the method further comprises of forming bounding boxes from combination of the first set of images and the second set of images and the third set of images. In some embodiments, the special camera is an infrared camera.

These and other aspects, their implementations and other features are described in detail in the drawings, the description and the claims.

In some embodiments, the invention relates a method of generating models.

In some embodiments, the method comprises a step of placing an item with a first kind of position on a rotating platform;

In some embodiments, the method comprises a step of taking a first set of images of the item with the first kind of position on the rotating platform, wherein multiple lighting levels and angles of the items are used to stimulate real store lighting conditions.

In some embodiments, the method comprises a step of taking a first series of images of hands from different individuals.

In some embodiments, the method comprises a step of placing the item with a second kind of position on the rotating platform.

In some embodiments, the method comprises a step of taking a second set of images of the item with the second kind of position on the rotating platform, multiple lighting levels and angles of the items are used to stimulate real store lighting conditions;

In some embodiments, the method comprises a step of taking a second series of images of different backgrounds.

In some embodiments, the method comprises a step of generating a set of training images by synthetically combining the first set of images, the second set of images, the first series of images and the second series of images.

In some embodiments, the method comprises a step of training a product recognition model by the set of training images on real time basis with a series of random augmentations.

In some embodiments, the method comprises a step of testing the product recognition model with another set of images of the item in various conditions.

In some embodiments, computer graphics technology is configured to change the multiple lighting levels and angles with software.

In some embodiments, an object is placed near the item to achieve partial occultation.

In some embodiments, the item and the different backgrounds are composed to simulate images of real stores with occlusion and real store lighting condition.

In some embodiments, the set of training images are mixed with real images in a real store in a randomized way.

In some embodiments, the set of training images are generated by a process of composition.

In some embodiments, the set of training images is configured to train a deep learning model to recognize a new product that has not been seen in real stores.

### BRIEF DESCRIPTION OF THE DRAWINGS

FIG. 1 shows an example of a method to generate models.

FIG. 2 shows an example of a method to differentiate products.

FIG. 3 shows another example of a method to generate models.

FIG. 4 shows an example of a diagram of a RBG camera and an infrared camera monitoring a customer picking up an item from a shelf .

FIG. 5 shows an example of the top view from the RBG camera of the customer picking up an item from a shelf in FIG. 4.

FIG. 6 shows an example of the top view from the infrared camera of the customer picking up an item from a shelf in FIG. 4.

FIG. 7 shows an example of a diagram of a RBG camera and an infrared camera monitoring a customer picking up two visually similar items from a shelf.

FIG. 8 shows an example of the top view from the RBG camera of the customer picking up two visually similar items from a shelf in FIG. 7.

FIG. 9 shows an example of the top view from the infrared camera of the customer picking up two visually similar items from a shelf in FIG. 7.

FIG. 10 shows an example of a method of generating models.

FIG. 11 shows another example of a method of generating models.

### DETAILED DESCRIPTION OF THE INVENTION

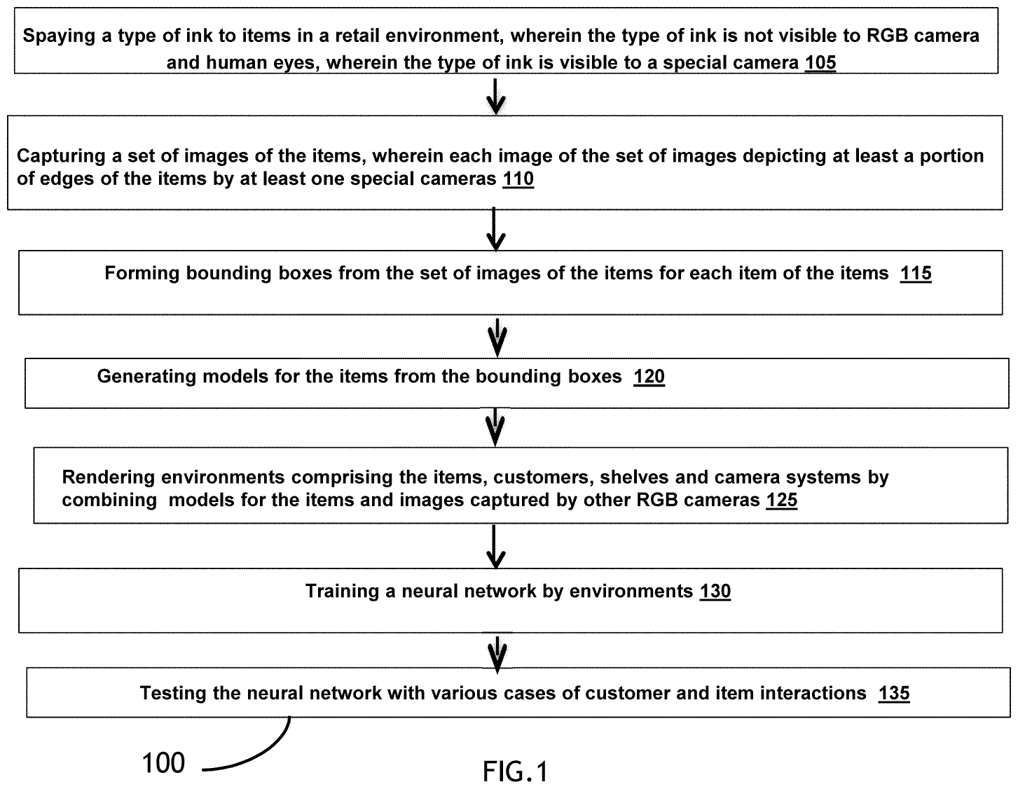

FIG. 1 shows an example of a method to generate models.

In some implementations, a method 100 of generating models, is comprising: a step 105 of spaying a type of ink to items in a retail environment, wherein the type of ink is not visible to RGB camera and human eyes, wherein the type of ink is visible to a special camera; a step 110 of capturing a set of images of the items, wherein each image of the set of images depicting at least a portion of edges of the items by at least one special cameras; a step 115 of forming bounding boxes from the set of images of the items for each item of the items; a step 120 of generating models for the items from the bounding boxes; a step 125 of rendering environments comprising the items, customers, shelves and camera systems by combining models for the items and images captured by other RGB cameras; a step 130 of training a neural network by environments; and a step 135 of testing the neural network with various cases of customer and item interactions.

In some embodiments, the special camera is configured to detect infrared signals.

In some embodiments, the special camera is configured to detect ultraviolet signals.

In some embodiments, the method is further comprising a step of taking another set of images of the items by a RGB camera.

In some embodiments, the method is further comprising a step of combining the set of images and the another set of images to generate another set of models.

In some embodiments, the set of images can only viewed by machines.

In some embodiments, the type of ink only sprayed to a segmentation of the items.

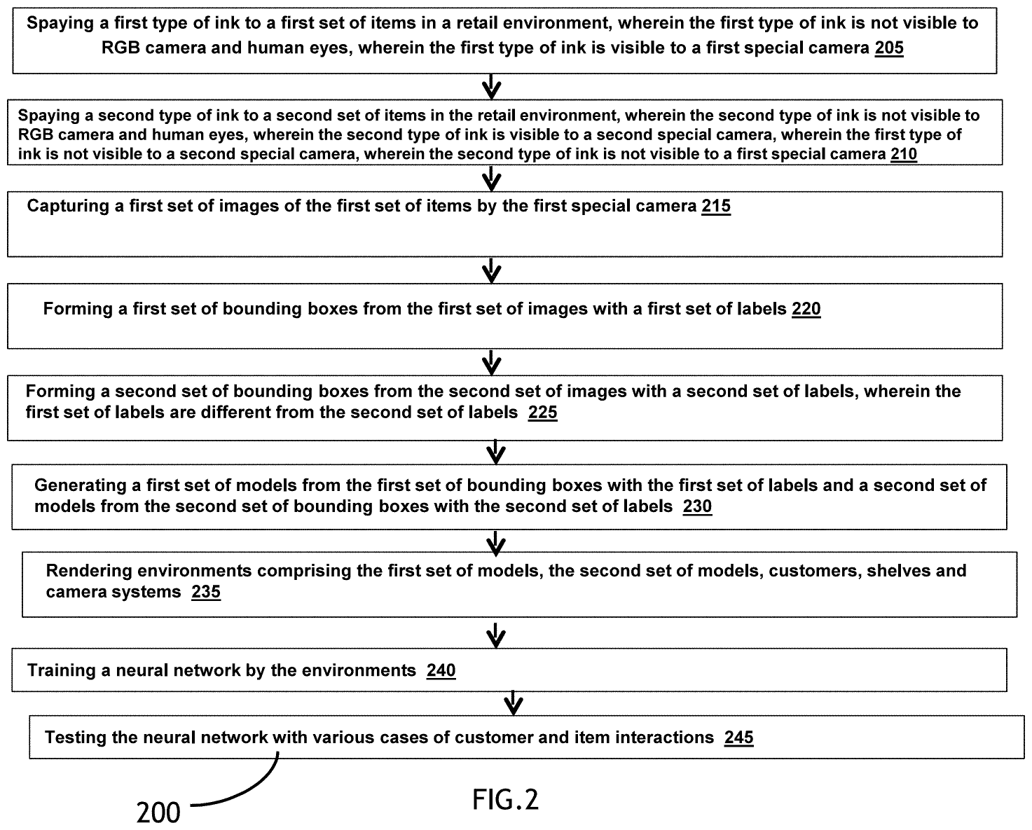

FIG. 2 shows an example of a method to differentiate products.

In some embodiments, a method 200 of to differentiate products, is comprising: a step 205 of spaying a first type of ink to a first set of items in a retail environment, wherein the first type of ink is not visible to RGB camera and human eyes, wherein the first type of ink is visible to a first special camera; a step 210 of spaying a second type of ink to a second set of items in the retail environment, wherein the second type of ink is not visible to RGB camera and human eyes, wherein the second type of ink is visible to a second special camera, wherein the first type of ink is not visible to a second special camera, wherein the second type of ink is not visible to a first special camera; a step 215 of capturing a first set of images of the first set of items by the first special camera; a step 220 of forming a first set of bounding boxes from the first set of images with a first set of labels; a step 225 of forming a second set of bounding boxes from the second set of images with a second set of labels, wherein the first set of labels are different from the second set of labels; a step 230 of generating a first set of models from the first set of bounding boxes with the first set of labels and a second set of models from the second set of bounding boxes with the second set of labels; a step 235 of rendering environments comprising the first set of models, the second set of models, customers, shelves and camera systems; a step 240 of training a neural network by the environments; and a step 245 of testing the neural network with various cases of customer and item interactions.

In some embodiments, the method is further comprising of capturing a third set of images of the items by a RGBD camera;

In some embodiments, the method further comprises of forming bounding boxes from combination of the first set of images and the second set of images and the third set of images.

In some embodiments, the special camera is an infrared camera.

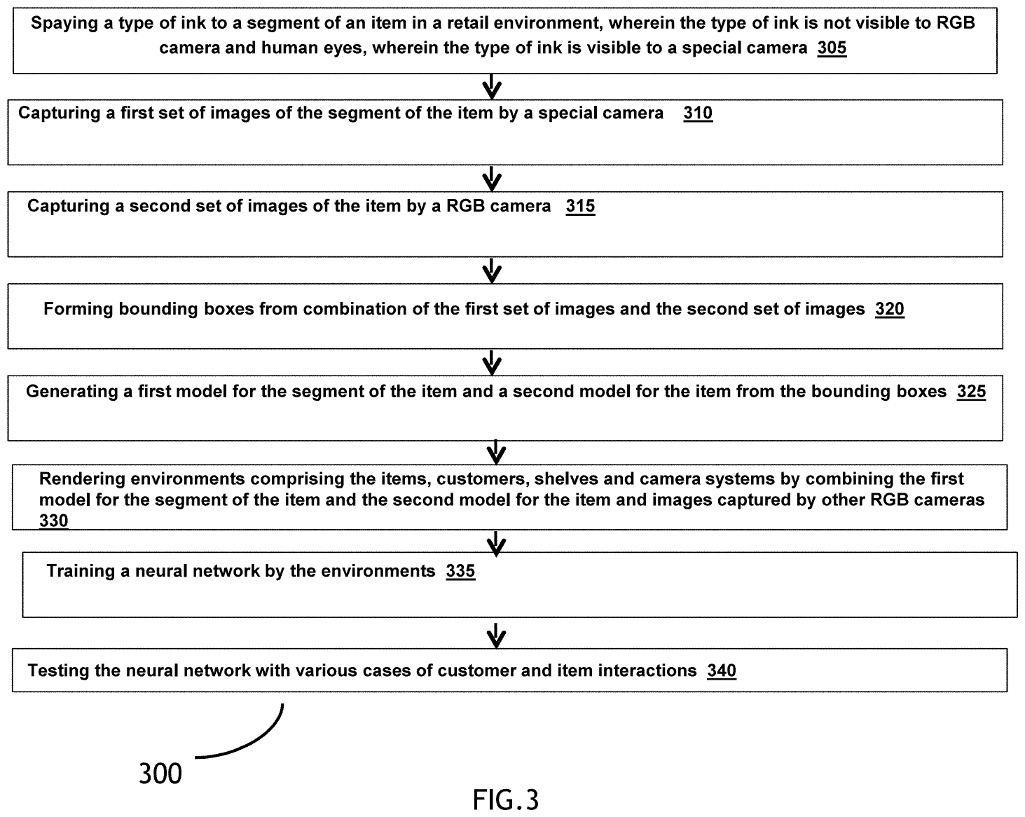

FIG. 3 shows another example of a method to generate models.

In some implementations, a method 300 to generate models, is comprising: a step 305 of spaying a type of ink to a segment of an item in a retail environment, wherein the type of ink is not visible to RGB camera and human eyes, wherein the type of ink is visible to a special camera; a step 310 of capturing a first set of images of the segment of the item by a special camera; a step 315 of capturing a second set of images of the items by a RGB camera; a step 320 of forming bounding boxes from combination of the first set of images and the second set of images; a step 325 of generating a first model for the segment of the item and a second model for the item from the bounding boxes; a step 330 of rendering environments comprising the items, customers, shelves and camera systems by combining the first model for the segment of the item and the second model for the item and images captured by other RGB cameras; a step 335 of training a neural network by the environments; a step 340 of testing the neural network with various cases of customer and item interactions.

In some embodiments, the method is further comprising of capturing a third set of images of the items by a RGBD camera; In some embodiments, the method further comprises of forming bounding boxes from combination of the first set of images and the second set of images and the third set of images. In some embodiments, the special camera is an infrared camera.

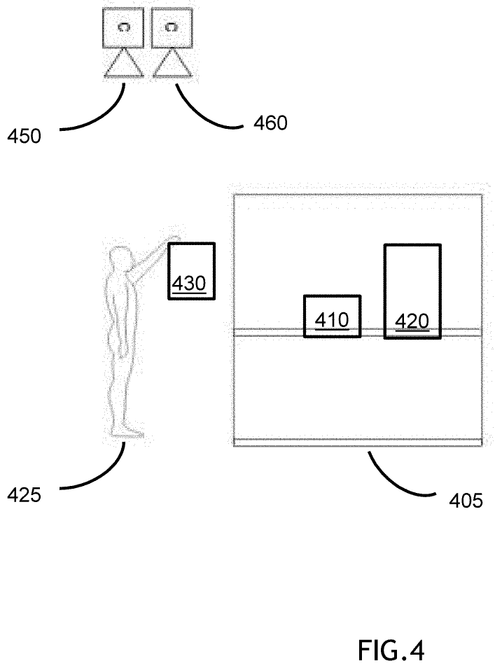

FIG. 4 shows an example of a diagram of a RBG camera and an infrared camera monitoring a customer picking up an item from a shelf.

In some embodiments, shelf 405 is a shelf that is configured to contain one or more products or items. In some embodiments, items 410, 420 and 430 could be visually different items. In some embodiments, items 410, 420 and 430 could also be visually similar items. In some embodiments, a customer 425 can pick up item 430 from the shelf. In some embodiments, the item 430 has been spread with a kind of ink that is visible to an infrared camera, while not visible to a RGB camera. In some embodiments, a RGB camera 450 can capture video or still images of customer 425, item 430, and shelf 405 from above. In some embodiments, an infrared camera 460 can capture infrared video or infrared still images of customer 425, item 430, and shelf 405 from above. In some embodiment, the RGB camera 450 and the infrared camera 460 can also view items 410 and 420, but in some other embodiments, the cameras cannot view items 410 and 420.

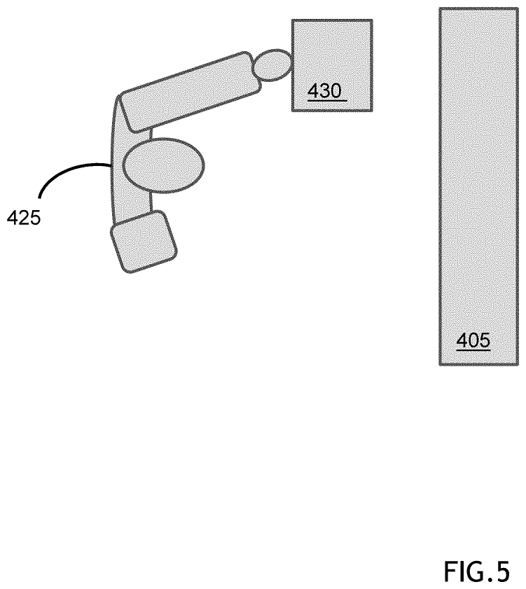

FIG. 5 shows an example of the top view from the RBG camera of the customer picking up an item from a shelf in FIG. 4. In some embodiments, the image shows the top view of shelf 405. In some embodiments, the image shows the top view of the customer 425 and the top view of the item 430.

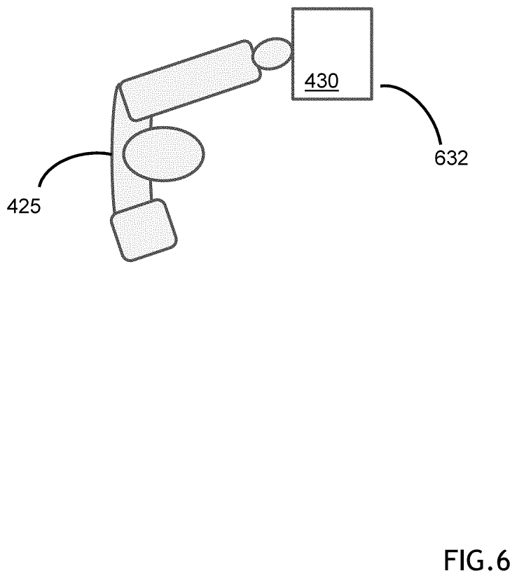

FIG. 6 shows an example of the top view from the infrared camera of the customer picking up an item from a shelf in FIG. 4. The infrared camera image cannot show the shelf because shelf has same temperature as in the surroundings. In some embodiments, the infrared camera image can show customer 425 with one color that depends on the body temperature of the customer 425. In some embodiments, the infrared camera can show item 430 with infrared visible ink on its cover. In some embodiments, the infrared camera can show item 430 with a pre-determined color based on the chemical composition of the infrared visible ink. In some embodiments, the color of the item 430 is different that the color of the customer 425. In some embodiments, by combining and processing both FIG. 5 and FIG. 6, a boundary box 632 of item 430 can be easily established.

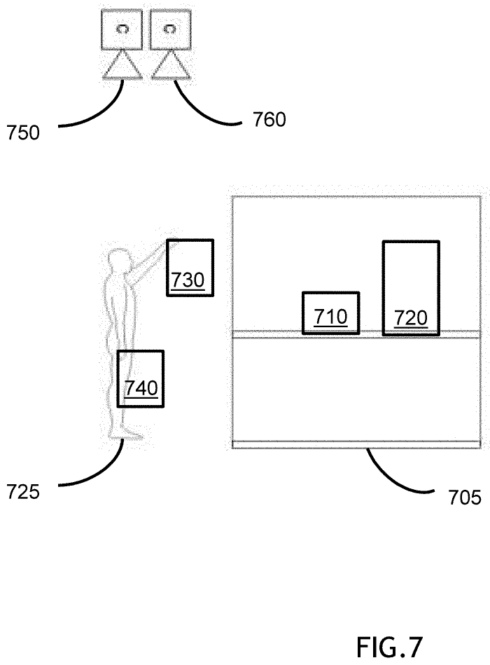

FIG. 7 shows an example of a diagram of a RBG camera and an infrared camera monitoring a customer picking up two visually similar items from a shelf. In some embodiments, shelf 705 is a shelf that is configured to contain one or more products or items. In some embodiments, items 710, 720, 730 and 740 are contained with the shelf 705. In some embodiments, items 730, and 740 could be visually similar items. In some embodiments, a customer 725 can pick up item 730 and 740 from the shelf. In some embodiments, the item 730 has been spread with a kind of ink that is visible to an infrared camera, while not visible to a RGB camera. In some embodiments, a RGB camera 750 can capture video or still images of customer 425, items 730 and 740, shelf 705 from above. In some embodiments, an infrared camera 760 can capture infrared video or infrared still images of customer 725, item 730 and 740, and shelf 705 from above. In some embodiment, the RGB camera 750 and the infrared camera 760 can also view items 410 and 420, but in some other embodiments, the cameras cannot view items 710 and 720.

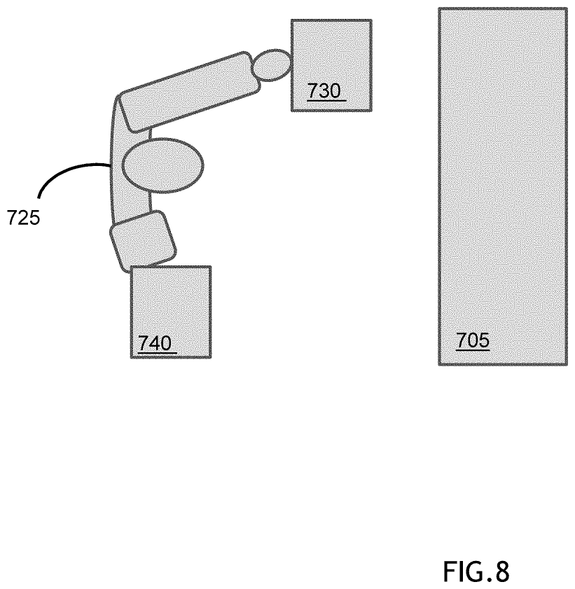

FIG. 8 shows an example of the top view from the RBG camera of the customer picking up two visually similar items from a shelf in FIG. 7. In some embodiments, the image shows the top view of shelf 705. In some embodiments, the image shows the top view of the customer 725 and the top view of the item 730 and the item 740.

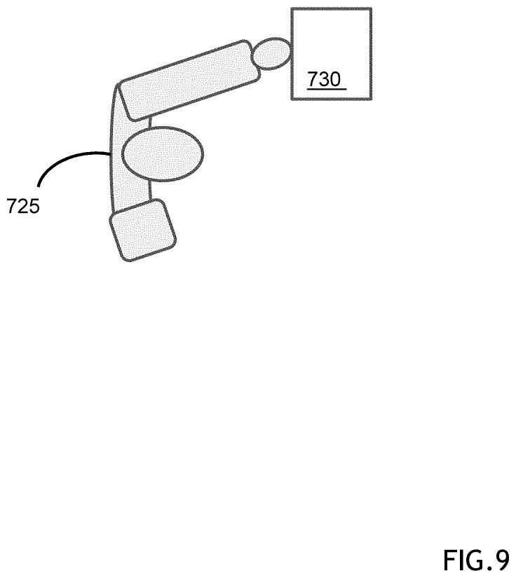

FIG. 9 shows an example of the top view from the infrared camera of the customer picking up two visually similar items from a shelf in FIG. 7. The infrared camera image cannot show the shelf because shelf has same temperature as in the surroundings. In some embodiments, the infrared camera image can show customer 725 with one color that depends on the body temperature of the customer 725. In some embodiments, the infrared camera can show item 730 with infrared visible ink on its cover. In some embodiments, the infrared camera can show item 730 with a pre-determined color based on the chemical composition of the infrared visible ink. In some embodiments, the infrared camera cannot show item 740 because no infrared ink on its cover. In some embodiments, the color of the item 730 is different that the color of the customer 725. In some embodiments, by combining and processing both FIG. 8 and FIG. 9, the system can easily differentiate item 730 from item 740.

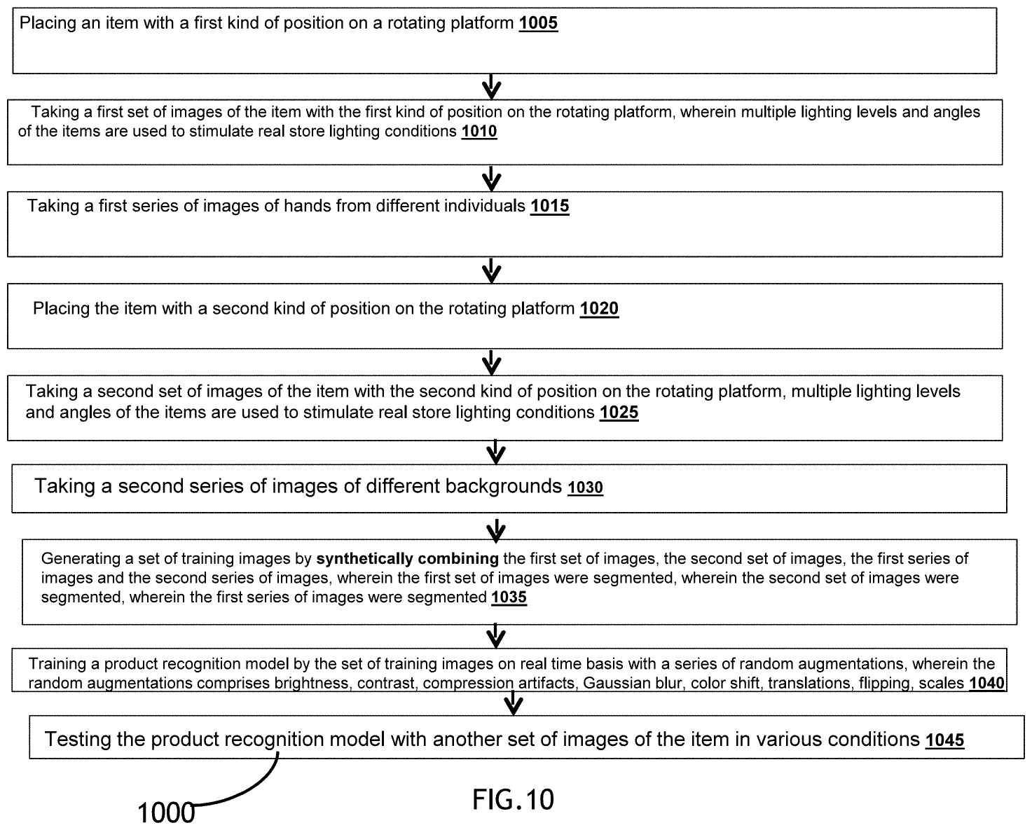

FIG. 10 shows an example of a method 1000 of generating models.

In some embodiments, the method 1000 comprises a step 1005 Placing an item with a first kind of position on a rotating platform;

In some embodiments, the method 1000 comprises a step 1010 of taking a first set of images of the item with the first kind of position on the rotating platform, wherein multiple lighting levels and angles of the items are used to stimulate real store lighting conditions.

In some embodiments, the method 1000 comprises a step 1015 of taking a first series of images of hands from different individuals.

In some embodiments, the method 1000 comprises a step 1020 of placing the item with a second kind of position on the rotating platform.

In some embodiments, the method 1000 comprises a step 1025 of taking a second set of images of the item with the second kind of position on the rotating platform, multiple lighting levels and angles of the items are used to stimulate real store lighting conditions;

In some embodiments, the method 1000 comprises a step 1030 of taking a second series of images of different backgrounds.

In some embodiments, the method 1000 comprises a step 1035 of generating a set of training images by synthetically combining the first set of images, the second set of images, the first series of images and the second series of images, wherein the first set of images were segmented, wherein the second set of images were segmented, wherein the first series of images were segmented.

In some embodiments, the method 1000 comprises a step 1040 of training a product recognition model by the set of training images on real time basis with a series of random augmentations, wherein the random augmentations comprises brightness, contrast, compression artifacts, Gaussian blur, color shift, translations, flipping, scales.

In some embodiments, the method 1000 comprises a step 1045 of testing the product recognition model with another set of images of the item in various conditions.

In some embodiments, computer graphics technology is configured to change the multiple lighting levels and angles with software.

In some embodiments, an object is placed near the item to achieve partial occultation.

In some embodiments, the item and the different backgrounds are composed to simulate images of real stores with occlusion and real store lighting condition.

In some embodiments, the set of training images are mixed with real images in a real store in a randomized way.

In some embodiments, the set of training images are generated by a process of composition.

In some embodiments, the set of training images is configured to train a deep learning model to recognize a new product that has not been seen in real stores.

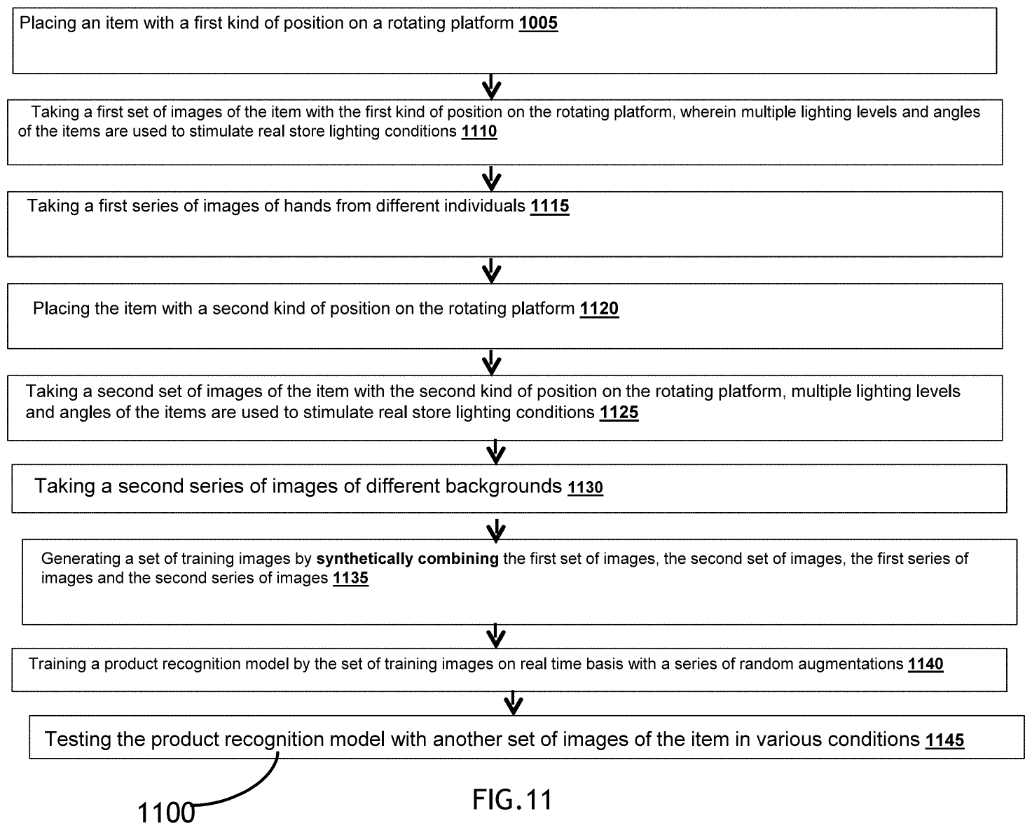

FIG. 11 shows an example of a method 1100 of generating models.

In some embodiments, the method 1100 comprises a step 1105 Placing an item with a first kind of position on a rotating platform;

In some embodiments, the method 1100 comprises a step 1110 of taking a first set of images of the item with the first kind of position on the rotating platform, wherein multiple lighting levels and angles of the items are used to stimulate real store lighting conditions,

In some embodiments, the method 1100 comprises a step 1115 of taking a first series of images of hands from different individuals.

In some embodiments, the method 1100 comprises a step 1120 of placing the item with a second kind of position on the rotating platform.

In some embodiments, the method 1100 comprises a step 1125 of taking a second set of images of the item with the second kind of position on the rotating platform, multiple lighting levels and angles of the items are used to stimulate real store lighting conditions;

In some embodiments, the method 1100 comprises a step 1130 of taking a second series of images of different backgrounds.

In some embodiments, the method 1100 comprises a step 1135 of generating a set of training images by synthetically combining the first set of images, the second set of images, the first series of images and the second series of images.

In some embodiments, the method 1100 comprises a step 1140 of training a product recognition model by the set of training images on real time basis with a series of random augmentations.

In some embodiments, the method 1100 comprises a step 1145 of testing the product recognition model with another set of images of the item in various conditions.

In some embodiments, computer graphics technology is configured to change the multiple lighting levels and angles with software.

In some embodiments, an object is placed near the item to achieve partial occultation.

In some embodiments, the item and the different backgrounds are composed to simulate images of real stores with occlusion and real store lighting condition.

In some embodiments, the set of training images are mixed with real images in a real store in a randomized way.

In some embodiments, the set of training images are generated by a process of composition.

In some embodiments, the set of training images is configured to train a deep learning model to recognize a new product that has not been seen in real stores.

1. A method of generating models, comprising:
Spaying a type of ink to items in a retail environment, wherein the type of ink is not visible to RGB camera and human eyes, wherein the type of ink is visible to a special camera;
Capturing a set of images of the items, wherein each image of the set of images depicting at least a portion of edges of the items by at least one special cameras;
Forming bounding boxes from the set of images of the items for each item of the items;
Generating models for the items from the bounding boxes;
Rendering environments comprising the items, customers, shelves and camera systems by combining models for the items and images captured by other RGB cameras;
Training a neural network by environments; and
Testing the neural network with various cases of customer and item interactions.

2. The method of generating models of claim 1, wherein the special camera is configured to detect infrared signals.

3. The method of generating models of claim 1, wherein the special camera is configured to detect ultraviolet signals.

4. The method of generating models of claim 1, further comprising:
Taking another set of images of the items by a RGB camera;
Combining the set of images and the another set of images to generate another set of models.

5. The method of generating models of claim 1, wherein the set of images can only viewed by machines.

6. The method of generating models of claim 1, wherein the type of ink only sprayed to a segmentation of the items.

7. A method of to differentiate products, comprising:
Spaying a first type of ink to a first set of items in a retail environment, wherein the first type of ink is not visible to RGB camera and human eyes, wherein the first type of ink is visible to a first special camera;
Spaying a second type of ink to a second set of items in the retail environment, wherein the second type of ink is not visible to RGB camera and human eyes, wherein the second type of ink is visible to a second special camera, wherein the first type of ink is not visible to a second special camera, wherein the second type of ink is not visible to a first special camera;
Capturing a first set of images of the first set of items by the first special camera;
Forming a first set of bounding boxes from the first set of images with a first set of labels;
Forming a second set of bounding boxes from the second set of images with a second set of labels, wherein the first set of labels are different from the second set of labels;
Generating a first set of models from the first set of bounding boxes with the first set of labels and a second set of models from the second set of bounding boxes with the second set of labels;
Rendering environments comprising the first set of models, the second set of models, customers, shelves and camera systems;
Training a neural network by the environments; and
Testing the neural network with various cases of customer and item interactions.

8. The method of differentiate products of claim 5, wherein the first special camera is configured to detect infrared signals.

9. The method of differentiate products of claim 5, wherein the second special camera is configured to detect ultraviolet signals.

10. The method of differentiate products of claim 7, wherein the first type of ink only sprayed to a segmentation of the first set of items.

9. The method of generating models, comprising:
Spaying a type of ink to a segment of an item in a retail environment, wherein the type of ink is not visible to RGB camera and human eyes, wherein the type of ink is visible to a special camera;
Capturing a first set of images of the segment of the item by a special camera;
Capturing a second set of images of the items by a RGB camera;
Forming bounding boxes from combination of the first set of images and the second set of images;
Generating a first model for the segment of the item and a second model for the item from the bounding boxes;
Rendering environments comprising the items, customers, shelves and camera systems by combining the first model for the segment of the item and the second model for the item and images captured by other RGB cameras;
Training a neural network by the environments;
Testing the neural network with various cases of customer and item interactions.

10. The method of generating models of claim 9, further comprising:
Capturing a third set of images of the items by a RGBD camera;
Forming bounding boxes from combination of the first set of images and the second set of images and the third set of images.

11. The method of generating models of claim 9, wherein the special camera is an infrared camera.

12. A method of generating models, comprising:
Placing an item with a first kind of position on a rotating platform;
Taking a first set of images of the item with the first kind of position on the rotating platform, wherein multiple lighting levels and angles of the items are used to stimulate real store lighting conditions;
Taking a first series of images of hands from different individuals;
Placing the item with a second kind of position on the rotating platform;
Taking a second set of images of the item with the second kind of position on the rotating platform, multiple lighting levels and angles of the items are used to stimulate real store lighting conditions;
Taking a second series of images of different backgrounds;
Generating a set of training images by synthetically combining the first set of images, the second set of images, the first series of images and the second series of images, wherein the first set of images were segmented, wherein the second set of images were segmented, wherein the first series of images were segmented;
Training a product recognition model by the set of training images on real time basis with a series of random augmentations, wherein the random augmentations comprises brightness, contrast, compression artifacts, Gaussian blur, color shift, translations, flipping, scales; and
Testing the product recognition model with another set of images of the item in various conditions.

13. The method of claim 12, wherein computer graphics technology is configured to change the multiple lighting levels and angles with software.

14. The method of claim 12, wherein an object is placed near the item to achieve partial occultation.

15. A method of claim 12, wherein the item and the different backgrounds are composed to simulate images of real stores with occlusion and real store lighting condition.

16. A method of claim 12, wherein the set of training images are mixed with real images in a real store in a randomized way.

17. A method of claim 12, the set of training images are generated by a process of composition.

18. A method of claim 12, the set of training images is configured to train a deep learning model to recognize a new product that has not been seen in real stores.

19. A method of generating models, comprising:
Placing an item with a first kind of position on a rotating platform;
Taking a first set of images of the item with the first kind of position on the rotating platform, wherein multiple lighting levels and angles of the items are used to stimulate real store lighting conditions;
Placing the item with a second kind of position on the rotating platform;
Taking a second set of images of the item with the second kind of position on the rotating platform, multiple lighting levels and angles of the items are used to stimulate real store lighting conditions;
Generating a set of training images by synthetically combining the first set of images, and the second series of images;
Training a product recognition model by the set of training images on real time basis with a series of random augmentations; and
Testing the product recognition model with another set of images of the item in various conditions.

20. The method of claim 19, wherein computer graphics technology is configured to change the multiple lighting levels and angles with software.

21. The method of claim 19, wherein an object is placed near the item to achieve partial occultation.

22. A method of claim 19, wherein the item and the different backgrounds are composed to simulate images of real stores with occlusion and real store lighting condition.

23. A method of claim 19, wherein the set of training images are mixed with real images in a real store in a randomized way.

24. A method of claim 19, the set of training images are generated by a process of composition.

25. A method of claim 19, the set of training images is configured to train a deep learning model to recognize a new product that has not been seen in real stores.
